(19) United States
(12) Patent Application Publication
(10) Pub. No.: US 2007/0263912 A1
(43) Pub. Date: Nov. 15, 2007

(54) Method Of Identifying An Individual From Image Fragments

(76) Inventors: Frederic Biarnes, Suresnes (FR); Pierre Chastel, Bourron (FR)

Correspondence Address: BIRCH STEWART KOLASCH & BIRCH, PO BOX 747, FALLS CHURCH, VA, 22040-0747, US

(21) Appl. No.: 11/791,999

(22) PCT Filed: Nov. 25, 2005
(86) PCT No.: PCT/FR05/02935

§ 371 Date: May 31, 2007

(30) Foreign Application Priority Data
Dec. 1, 2004 (FR) 0412737

(51) Int. Cl. G06K 9/00

(52) U.S. Cl. 382/124

(57) ABSTRACT

A method of identifying an individual from fragments (1, 2, 3) of an image (5) of at least a portion of that individual, and on the basis of data containing the characteristics of images of a plurality of individuals, the method comprising the steps of: identifying characteristics of the image fragments;

from the characteristics, determining whether the image fragments correspond to a single image, and grouping together fragments that correspond to form a group (4); and comparing the characteristics of the group with the characteristics of images contained in the database.

The present invention relates to a method of identifying an individual from image fragments relating to at least a portion of that individual, and from a database containing the characteristics of images of individuals.

### BACKGROUND OF THE INVENTION

After a crime (the term “crime” being used broadly to cover any kind of wrongdoing, felony, misdemeanor, . . . ), it is known in particular to take prints of fingers, palms, . . . left on a crime site in an attempt to identify the criminal or potential witnesses of the crime. Fingerprints are in the form of lines that present shapes, interruptions, intersections, directions, etc., that constitute characteristics that make them unique and specific to one individual. These characteristics are located and encoded for the purpose of being compared with the characteristics of fingerprints that are stored in a database of individuals so that, where possible, one of those individuals can be identified as possessing fingerprints that are the same as those taken from the site. The number of characteristics in common makes it possible to assess how probable it is that a fingerprint taken from the site is the same as a fingerprint that has been stored. The major part of the encoding and comparison operations is performed by algorithms implemented on computers, and the success rate is relatively high.

In order to further improve the success rate of such an identification method, most professionals have concentrated on improving the encoding of the characteristics of fingerprints taken from a site in order to eliminate noise from those fingerprints (e.g. elements forming part of the medium carrying the fingerprint, such as the typography on printed paper or furrows in a piece of leather), and in order to limit the risk of creating false characteristics.

However, it would appear that one approach for improving the success rate has not yet been exploited to the full.

It happens commonly that fingerprints taken from crime sites are incomplete and constitute no more than fingerprint fragments. When the characteristics of such fragments are compared with characteristics in the database, there is a risk that the number of characteristics present on the fragment, or the accuracy with which they are positioned, is not sufficient to enable a reliable comparison to be achieved. Such fingerprint fragments are therefore set aside during computer programming, or do not give results that are pertinent for a reliable comparison.

One solution to that problem would consist in recording the proximity of fragments taken from the site of a crime so as to associate proximity information with the fragments. The characteristics of fragments that are close together could then be compared simultaneously with the characteristics of stored fingerprints. It is possible to envisage making use of such new information that needs to be interpreted on a case-by-case basis when processing is carried out by specialists, but that would complicate computer processing without improving its reliability.

Document US-A-2002/003892 also discloses a method of verifying the identity of the user of a mobile telephone that includes a camera and a memory containing characteristics of a fingerprint of the user. In order to enable a user to validate his or her own identity, the user places a finger on the camera, and since the camera cannot capture an entire fingerprint all at once because of the small size of its sensor, the camera captures fragmentary images of the fingerprint so as to be in a position to assemble those fragmentary images together and reconstitute a complete image of the fingerprint. The characteristics of the fingerprint that appear in the complete image are then compared with the characteristics in the memory in order to verify the identity of the user. In that method, it is known as a starting point that all of the fragmentary images do indeed correspond to a single fingerprint and that the fragmentary images are sensed in such a manner as to enable them to be reassembled. That is why that method is appropriate for no more that mere verification of identity and is far removed from performing identification of this kind described previously. Document WO-A-01/80167 describes an analogous method.

### OBJECT OF THE INVENTION

An object of the invention is to propose a method of identification that can make use of fragments of images.

### BRIEF SUMMARY OF THE INVENTION

To this end, the invention provides a method of identifying an individual from fragments of an image of at least a portion of that individual, and on the basis of data containing the characteristics of images of a plurality of individuals, the method comprising the following steps:

identifying characteristics of the image fragments;

from the characteristics, determining whether the image fragments correspond to a single image, and grouping together fragments that correspond to form a group; and

comparing the characteristics of the group with the characteristics of images contained in the database.

Thus, the group of fragments can contain a number of characteristics that is sufficient to enable the group to be validly compared with the characteristics of images in the database. The use of such fragments makes it possible to obtain additional information for identifying an individual.

Other characteristics and advantages of the invention appear on reading the following description of a particular, non-limiting implementation of the invention.

### BRIEF DESCRIPTION OF THE DRAWING

Reference is made to the accompanying drawing, in which:

FIGS. 1, 2, and 3 are views showing fragments of fingerprints;

FIG. 4 is a view showing fragments grouped together; and

FIG. 5 is a view of a fingerprint.

### DETAILED DESCRIPTION OF THE INVENTION

A fingerprint comprises lines of shape, intersections, interruptions, directions, . . . that constitute characteristics that make it unique and specific to one individual.

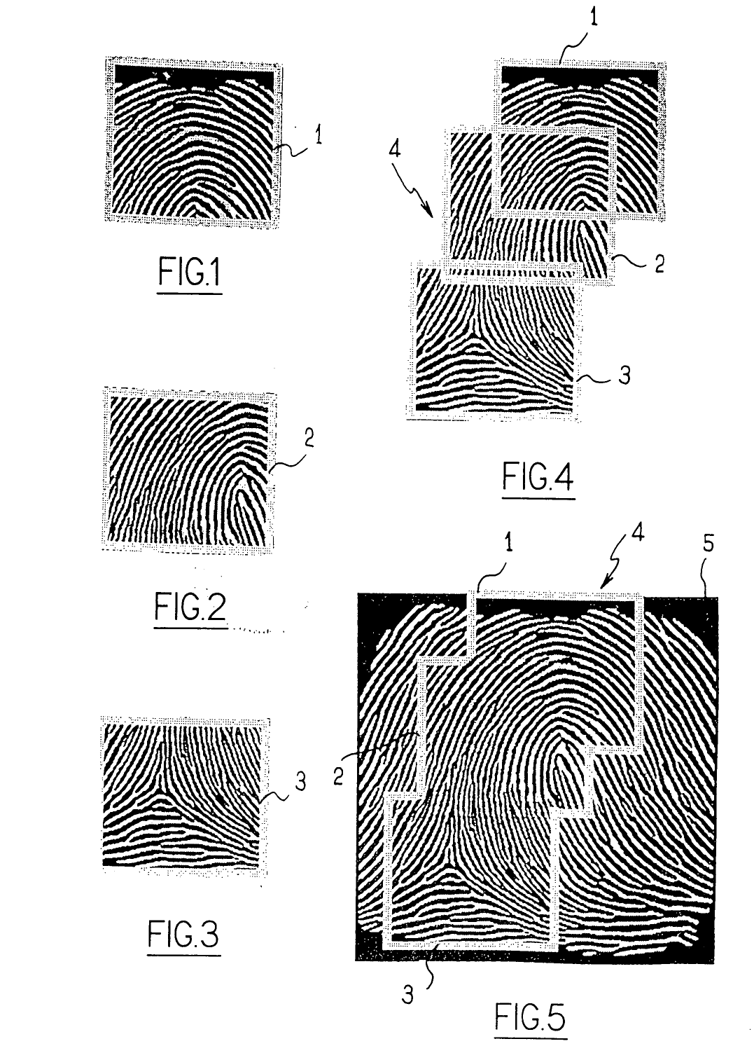

FIGS. 1, 2, and 3 show fragments 1, 2, and 3 of such a fingerprint, which fragments might in particular have been found, amongst others, at the site of a crime.

Each of the fragments includes a certain number of the above-mentioned characteristic points.

These fragments 1, 2, 3 are recovered in the form of digital files coming either directly from a digital camera or from scanning a photograph of a fragment.

The method in accordance with the invention begins with a step of identifying (or locating) the characteristics of the fragments and of encoding them in digital form (the term “encoding” is used herein to mean putting the characteristics of fragments into a form that enables them to be compared, e.g. in the form of point coordinates, and line direction angles, and/or indications relating to the nature of the characteristic, . . . ). This step may be performed automatically by a known encoding algorithm implemented on a computer, or manually by an operator informing a computer about the characteristics in an image of the fragment as displayed on the computer screen. These two techniques for locating characteristics and the following encoding are performed in conventional manner.

The following step consists in determining whether a plurality of fragments 1, 2, 3 correspond or belong to the same fingerprint. This determination is performed on the basis of the encoded characteristics.

In a first determination technique, correspondence is determined by searching for characteristics that are identical in the fragments. This determination serves to identify fragments that overlap.

In a second determination technique, for fragments comprising lines, said determination is performed by looking for coincidences between lines, in particular in the vicinity of the edges of fragments.

This determination serves to identify fragments that are continuous by looking for line continuities. One approach is to calculate a period for lines at one edge of one of the fragments and to search for such a period at different locations on other fragments.

This determination can also identify fragments that overlap.

In a third determination technique, the fragments include lines, and determination is based on the shapes of the lines, by looking for compatibilities between the shapes of lines belonging to the fragments.

Attempts are then made to find potential theoretical positions of each fragment and to verify whether those theoretical positions of the fragments are mutually compatible. Such theoretical positions are searched for in the shapes of the lines of the fragments as a function of a fingerprint classification that reveals the possible positions of lines as a function of their shape.

Those various determination techniques and others can be used singly or in succession to improve the reliability with which determination is performed.

When fragments 1, 2, 3 are identified as belonging to a single fingerprint, then the fragments are grouped together to produce a group 4.

The group 4 then presents some number of characteristics that is greater than the number of characteristics in each of the fragments 1, 2, 3 taken individually (at best equal to the sum of the numbers of characteristics in each fragment, but generally equal to a little less because of fragments overlapping).

The characteristics of the group 4 are then compared with the characteristics of fingerprints of individuals who have been identified and whose characteristics have been stored in a database.

When the number of characteristics common to the group 4 and to one of the fingerprints 5 in the memory is greater than a threshold, then the possessor of the fingerprint is assumed to be the same person as the person who left the fingerprint fragments at the site of a crime.

Naturally, the invention is not limited to the implementations described above, but on the contrary covers any variant using equivalent means to reproduce the essential characteristics specified above.

In particular, the invention is applicable to images of types other than fingerprints, and for example to images representing portions of the face.

1. A method of identifying an individual from fragments (1, 2, 3) of an image (5) of at least a portion of that individual, and on the basis of data containing the characteristics of images of a plurality of individuals, the method comprising the following steps:
identifying characteristics of the image fragments;
from the characteristics, determining whether the image fragments correspond to a single image, and grouping together fragments that correspond to form a group (4); and
comparing the characteristics of the group with the characteristics of images contained in the database.

2. An identification method according to claim 1, wherein correspondence is determined by searching for identical characteristics in the fragments (1, 2, 3).

3. An identification method according to claim 1, wherein, for fragments (1, 2, 3) including lines, determination is performed by searching for coincidences between lines.

4. An identification method according to claim 1, wherein, for fragments (1, 2, 3) including lines, determination is based on the shapes of the lines by searching for compatibilities between the line shapes of the fragments.
